(19) United States
(12) Patent Application Publication
(10) Pub. No.: US 2017/0221041 A1
(43) Pub. Date: Aug. 3, 2017

(54) APP TO APP PAYMENT

(71) Applicant: BPAY GROUP LIMITED, Sydney (AU)

(72) Inventor: Keith Brown, Rhodes (AU)

(73) Assignee: BPAY GROUP LIMITED, Sydney (AU)

(21) Appl. No.: 15/500,359

(22) PCT Filed: May 28, 2015
(86) PCT No.: PCT/AU2015/050287

§ 371 Date: Jan. 30, 2017

(30) Foreign Application Priority Data
Aug. 1, 2014 (AU) 2014902976

(51) Int. Cl. G06Q 20/32

(52) U.S. Cl. CPC G06Q 20/322

(57) ABSTRACT

This disclosure relates to facilitating payment by a payer using a payee application installed on a mobile communication device. The device detects an interaction by the payer with respect to the payee application to initiate a payment. In response to detecting the interaction, the device selects one of multiple payment applications installed on the mobile communication device and activates the one of the multiple payment applications to allow the payer to interact with the one of the multiple payment applications using a graphical user interface provided by the one of the multiple payment applications. Finally, the device sends payment data associated with the payment from the payee application to the one of the multiple payment applications to facilitate the payment. The payer can interact with the trusted payment application, which is an advantage over other payment methods where the payer provides credit card numbers directly to the payee.

### CROSS-REFERENCE TO RELATED APPLICATIONS

The present application claims priority from Australian Provisional Patent Application No 2014902976 filed on 1 Aug. 2014, the content of which is incorporated herein by reference.

### TECHNICAL FIELD

This disclosure relates to facilitating payment by a payer using a payee application installed on a mobile communication device.

### BACKGROUND

A large number of consumers use online shopping to buy goods or services from a wide variety of online merchants. Many online merchants offer customised software applications (apps) for mobile communication devices, such as tablet computers or smartphones. Consumers install these applications on their personal devices to buy goods or services. As a result, more and more payments are made in those apps instead of conventional internet sites. A common procedure for payment involves the payer providing credit card details to the merchant's app.

However, it is difficult for a merchant to implement payment functionality in their app, which is secure and complies with various privacy and payment regulations. Further, for consumers buying from many different merchants it is cumbersome to provide credit card details for each merchant separately. Additionally, it is difficult for the consumer to assess whether a particular merchant is trustworthy and will take due care when dealing with credit card information.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

A method for facilitating payment by a payer using a payee application installed on a mobile communication device comprises:

detecting an interaction by the payer with respect to the payee application to initiate a payment;

in response to detecting the interaction selecting one of multiple payment applications installed on the mobile communication device;

activating the one of the multiple payment applications to allow the payer to interact with the one of the multiple payment applications using a graphical user interface provided by the one of the multiple payment applications; and

sending payment data associated with the payment from the payee application to the one of the multiple payment applications to facilitate the payment.

Most payers are used to their payment applications and trust these applications because they are provided by their financial institution. Since the payment application is activated, the payer can interact with the trusted payment application. This is an advantage over other payment methods where the payer provides sensitive information, such as credit card numbers, directly to the payee. It is also an advantage for the payee that the sensitive information is stored only by the financial institution and the payee can reduce the cost for secure and compliant storage of sensitive information.

Since the method comprises selecting one of multiple applications installed on the mobile device, it is possible for a user to use the method if the user has accounts with different banks and has installed an application for each of these banks on the device. This is a further advantage over other methods that are restricted to a single bank or payment provider and therefore, less useful.

Selecting the one of multiple payment applications may be based on an indication associated with each of the multiple payment applications of whether that payment application accepts payment data.

It is an advantage that payment applications that are installed on the device but do not accept payment data can be disregarded from the selection.

Selecting the one of multiple payment applications may comprise receiving user input indicative of a selection of the one of the multiple payment applications by the user.

Each of the multiple payment applications may be associated with a bank.

The method may further comprise:

receiving from a server data indicative of a set of payment applications that accept payment data; and

determining for each of the multiple payment applications installed on the mobile communication device whether that payment application corresponds to an item in the received set of payment applications.

The steps of activating and sending may be performed in a single step of calling the one of the multiple payment applications using the payment data as a parameter for calling the one of the multiple payment applications.

Activating the one of the multiple payment applications may comprise accessing payer account data associated with the one of the multiple payment applications and the payer and displaying the payer account data to the payer.

Activating the one of the multiple payment applications may comprise starting a new process associated with the one of the multiple payment applications.

Activating the one of the multiple payment applications may comprise identifying a process associated with the one of the multiple payment applications and switching a user interface to the identified process.

The method may further comprise after the step of activating the one of the multiple payment applications receiving by the one of the multiple payment applications from the payer an indication to authorise the payment.

The indication may comprise authentication data to authenticate the payer with the one of the multiple payment applications.

The method may further comprise receiving from the one of the multiple payment applications a payment confirmation message and creating a display that indicates that the payment is confirmed.

Software when installed on a computer causes the computer to perform the above method.

A mobile communication device for facilitating payment by a payer using a payee application installed on the mobile communication device comprises:

an input port to detect an interaction by the payer with respect to the payee application to initiate a payment;

a processor to
select in response to detecting the interaction one of multiple payment applications installed on the mobile communication device,
activate the one of the multiple payment applications to allow the payer to interact with the one of the multiple payment applications using a graphical user interface provided by the one of the multiple payment applications, and
to send payment data associated with the payment from the payee application to the one of the multiple payment applications to facilitate the payment.

Optional features described of any aspect of method, computer readable medium or computer system, where appropriate, similarly apply to the other aspects also described here.

### BRIEF DESCRIPTION OF DRAWINGS

An example will be described with reference to

FIG. 1 illustrates a mobile communication device.

FIG. 2 illustrates a method for facilitating payment by payer.

FIG. 3 schematically illustrates the program memory of FIG. 1 in more detail.

FIG. 4 illustrates a home screen of the mobile communication device of FIG. 1.

FIG. 5 illustrates a virtual shopping cart in a merchant application user interface.

FIG. 6 illustrates a further merchant application user interface that allows a payer to select a bank.

FIG. 7 illustrates a payment application user interface.

FIG. 8 illustrates another example of a payment application user interface.

FIG. 9 illustrates a payment confirmation user interface of the merchant application.

FIG. 10 illustrates a computer network for managing payment applications.

### BEST MODE FOR CARRYING OUT THE INVENTION

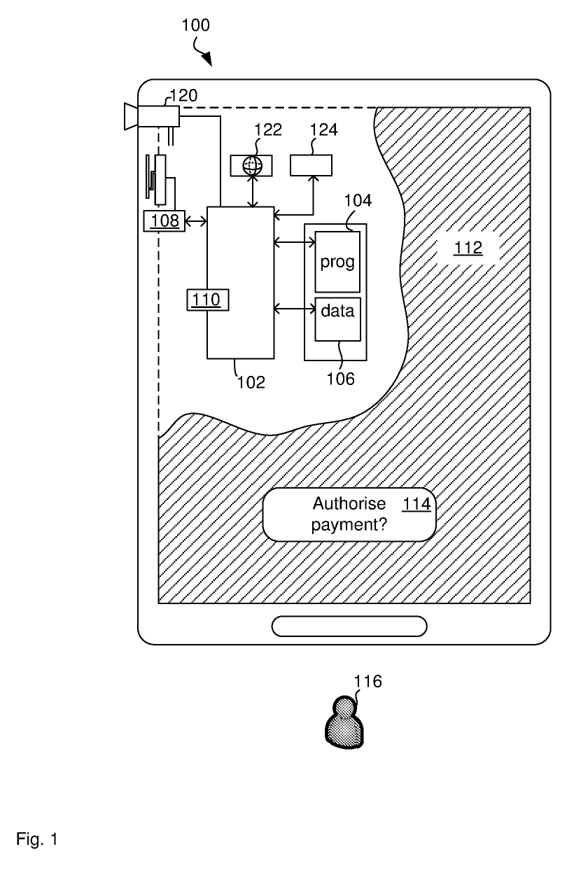

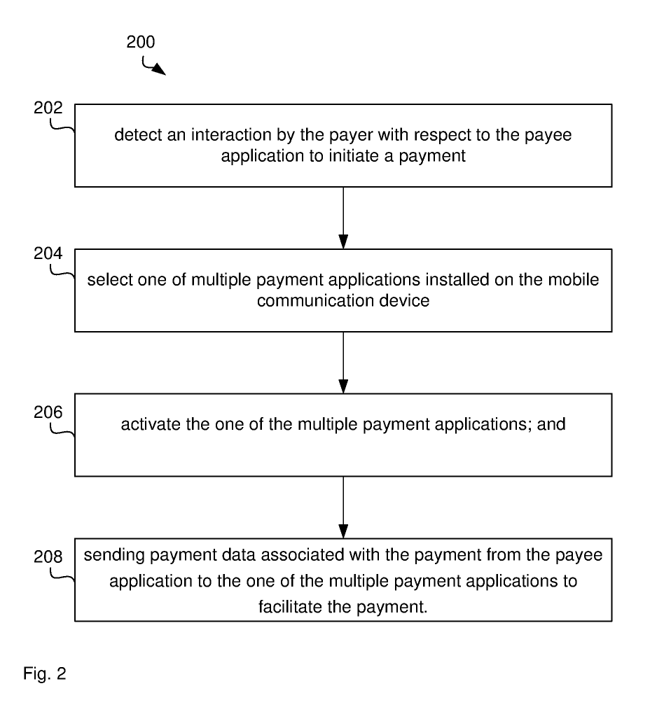

FIG. 1 illustrates a mobile communication device 100, such as a tablet computer or smartphone, for facilitating payment by a payer. The computer system 100 comprises a processor 102 connected to a program memory 104, a data memory 106, a communication port 108 and a user port 110. The program memory 104 is a non-transitory computer readable medium, such as a hard drive, a solid state disk or CD-ROM. Software, that is, an executable program stored on program memory 104 causes the processor 102 to perform the method in FIG. 2, that is, processor 102 detects an interaction, selects one of multiple payment applications, activates the selected payment application and sends payment data to the payment application.

The processor 102 may then store the payment data on data store 106, such as on RAM or a processor register.

The processor 102 may receive data, such as payment data, from data memory 106 as well as from the communications port 108 and the user port 110, which is connected to a display 112 that shows a graphical user interface 114 of an merchant or payment application to a payer 116.

Although communications port 108 and user port 110 are shown as distinct entities, it is to be understood that any kind of data port may be used to receive data or indications of user interaction, such as a network connection, a memory interface, a pin of the chip package of processor 102, or logical ports, such as IP sockets or parameters of functions stored on program memory 104 and executed by processor 102. These parameters may be stored on data memory 106 and may be handled by-value or by-reference, that is, as a pointer, in the source code.

The processor 102 may receive data through all these interfaces, which includes memory access of volatile memory, such as cache or RAM, or non-volatile memory, such as an optical disk drive, hard disk drive, flash drive, storage server or cloud storage.

It is to be understood that any receiving step may be preceded by the processor 102 determining or computing the data that is later received. The processor 102 may request the data from the data memory 106, such as by providing a read signal together with a memory address. The data memory 106 provides the data as a voltage signal on a physical bit line and the processor 102 receives the data via a memory interface. In this example, mobile communication device 100 further comprises a camera 120, a GPS receiver 122 and an module of inertial sensors 124.

FIG. 2 illustrates a method 200 as performed by processor 102 for facilitating payment by payer 116. Payer 116 uses a payee application, such as a merchant application, installed on program memory 104 of the mobile communication device 100 to purchase goods or services.

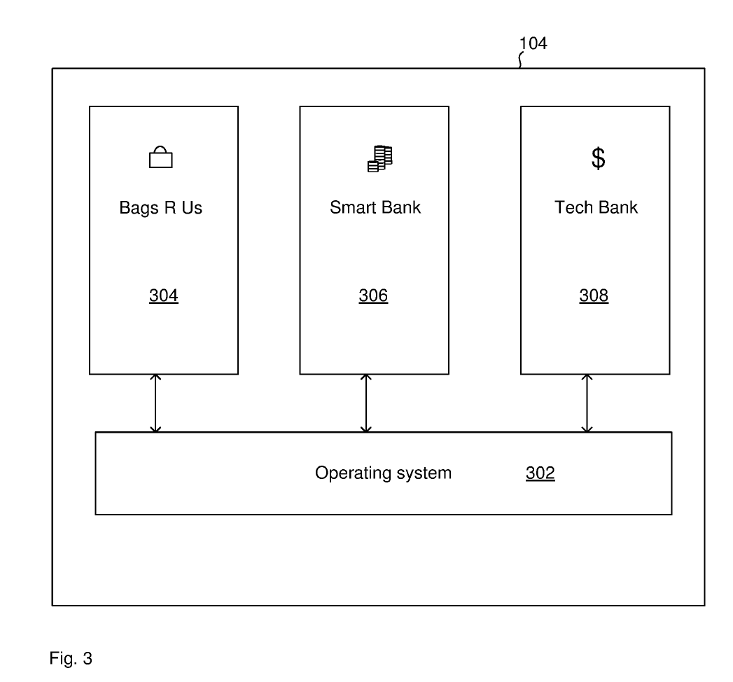

FIG. 3 schematically illustrates the program memory 104 in more detail. Installed on program memory 104 is an operating system 302, such as Android or iOS, which provides basic functionality and program access to the hardware of the device 100. Also installed on program memory 104 is a merchant application 304, a first payment application 306 and a second payment application 308. It is noted that merchant application 304 may be any application that allows payments to be made, such as a merchant application for purchasing goods or services in an online shop or an online game that allows in-game or in-app purchases, or any other payee application, such as an application for making a payment to a superannuation account or paying bills.

The three applications 304, 306 and 308 communicate with operating system 302 to access hardware functionality, such as creating a user interface on display 112 or receiving user input from payer 116. For example, display 112 may be a touch screen and the user input may be generated by the user selecting controls on the display 112 by tapping the display 112 with one or more fingers.

Each of the two payment application 306 and 308 may be associated with a bank. For example, the payer 116 has an account with a particular bank and accesses an application store, such as Apple's AppStore or Google play to install a payment application. The payer 116 can verify that the provider of the payment application is the actual bank that the payer 116 has an account with.

The three applications 304, 306 and 308 may store data on data store 106. For example, payer 116 may log into the second payment application 308 and second payment application 308 stores the user identifier and login data on data store 106. This way, if the payer 116 wishes to log into the second payment application 308 again after the previous session has expired or after the payer has logged out, the second payment application 308 can retrieve the user identifier from the data store 106, which allows the payer 116 to log into the second payment application 308 without providing the user identifier another time.

Even further, in cases where access to the entire mobile communication device 100 is protected by a secure password or fingerprint sensor etc., the second payment application 308 may require no authentication at all to access account data but may require a password or PIN to authorise payments. The provider of each payment application may provide security rules that govern the use of passwords and other security measures.

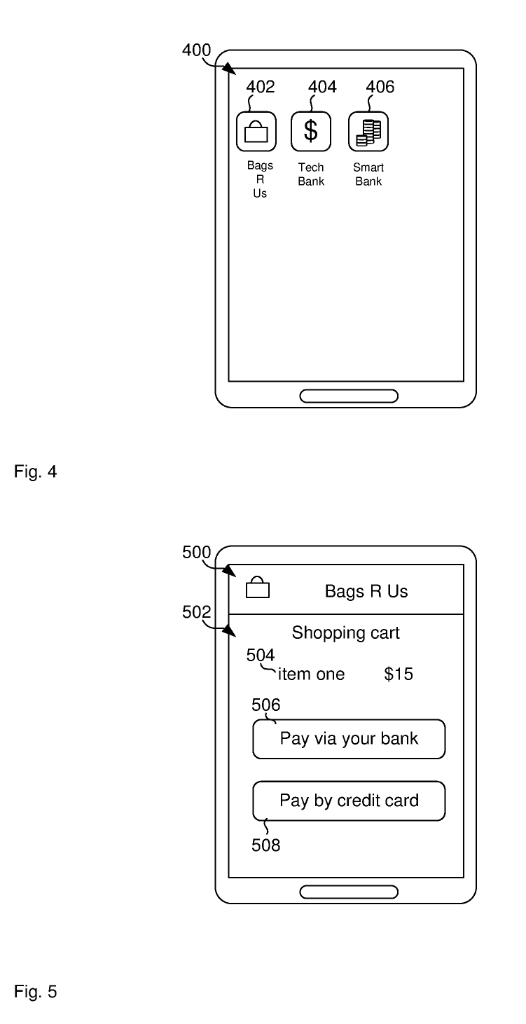

FIG. 4 illustrates a home screen 400 displayed on display 112. Home screen 400 comprises a merchant icon 402 associated with merchant application 304, a first payment icon 404 associated with first payment application 306 and a second payment icon 406 associated with second payment application 308. Although FIGS. 3 and 4 refer to two payment applications 306/308 and 404/406, it is to be understood that more payment application may also be installed. Payer 116 taps on merchant icon 402 to start merchant application 304.

FIG. 5 illustrates a merchant application user interface 500 displaying a virtual shopping cart 502 having one item 504. Interface 500 further comprises a first user control element 506 that allows payer 116 to make a payment according to method 200 and a second user control element 508 that allows payer 116 to make a payment using conventional credit card processes.

In one example, method 200 is implemented as a software development kit (SDK) providing an application programming interface (API). In this example, the merchant can implement the merchant application 306 as usual but includes the API into the application 304, such that the application 304 can call functions of the API to facilitate payment. The API may provide a function ‘generatePaymentControl’ which the merchant application 304 calls. As a result of calling that function, the API generates the first user control element 506 in merchant application user interface 500.

When the payer 116 taps on the first user control element 506, processor 102 detects 202 this interaction by the payer with respect to the merchant application to initiate a payment. For example, the API integrated into the merchant application 304 implements an onClick event handler that causes the following steps to be performed.

In response 204 to detecting the interaction processor 102 selects one of the two payment applications 306 or 308 installed on the mobile communication device. For example, the processor 102 analyses records of all applications that are installed on mobile device 100 and checks which applications are payment applications. Then, processor 102 accesses user preferences to determine whether one of the payment applications is a default payment application and selects the default payment application.

Further, processor 102 may access application data to determine whether the payment applications 306 and 308 are configured to be used for in-app payments, that is, whether they accept payment data from merchant applications. In one example, this application data is a flag associated with the application. This flag may be provided by financial institutions implementing the respective payment application.

As the SDK implementing method 200 is adopted by more users, banks may increasingly implement their payment applications such that they can receive data from merchant applications to allow in-app purchases. When payer 116 then updates the payment applications through conventional means, such as an app store, the new version is installed that provides the functionality of receiving data from the merchant application.

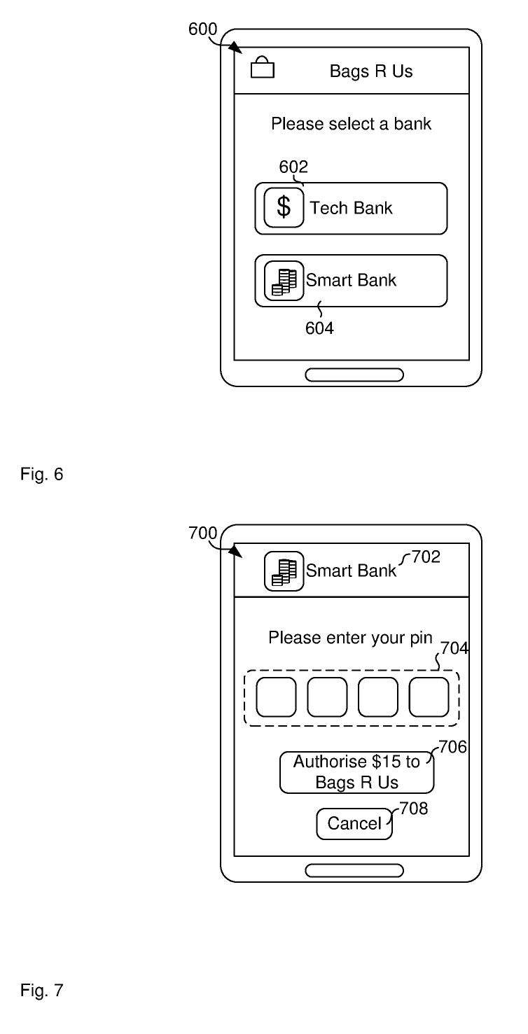

FIG. 6 illustrates a further merchant application user interface 600 that allows payer 116 to select a bank. User interface 600 comprises a first user selection control 602 associated with the first payment application 306 and a second user selection control 604 associated with second payment application 308. Payer 116 taps one of the controls 602 and 604 and processor 102 receives an indication of which of the controls 602 and 604 was selected by the user, such as by calling a further onClick event handler. Based on this indication, processor 102 selects one of the two payment applications 306 and 308.

In this example, processor 102 determines that both payment applications 306 and 308 accept payment data from a merchant application 304 and payer 116 decides to pay using the second payment application 308 and therefore, payer 116 taps second user selection control 604.

In response to receiving the selection 604, processor 102 activates 206 the second payment application 308 to allow the payer 116 to interact with the second payment application 116 using a graphical user interface provided by the second payment application 116. Activating may comprise starting a process of the payment application 308, also referred to launching the payment application 308, if the payment application 308 is not running. Activating may also comprise bringing the payment application 308 into focus if the payment application is already running but the screen 112 is taken up by the merchant application 304. Processor 102 may identify a process that is associated with the second payment application 308, such as by performing commands ‘ps’ and ‘grep’ to find the appropriate process.

Once the payment application 308 is activated or at the same time as activating the payment application 308, processor 102 sends 208 payment data associated with the payment from the merchant application to the payment application 308 to facilitate the payment. In one example, the payment data comprises the payment amount and account information of the merchant. Other data may also be included into the payment data, such as data related to purchased items, the merchant name or a customer reference for the payer 116 as generated by the merchant.

In one example, processor 102 sends the payment data in the form of a URL when activating the application 308, such as “secondApp?payment_amount=1500&merchant=bags_r_us”

FIG. 7 illustrates a payment application user interface 700 of payment application 308. The payment application user interface 700 is displayed as a result of the processor 102 activating payment application 308. User interface 700 comprises a name display 702 of the financial institution that is associated with this payment application 308 or that has issued payment application 308. This way, payer 116 can see that the display is now controlled by trusted payment application 308 and not by the potentially untrusted merchant application 304.

User interface 700 further comprises a pin input field 704 that allows the payer 116 to interact with the payment application 308 by providing a pin or other authentication data that is associated with the corresponding financial institution. Of course, the pin input field 704 may be replaced by a more general password input field to authenticate the payer 116 with the second payment application 308. The payer 116 enters the secret pin into pin input field 704 and selects an authorise control field 706. Alternatively, the payer 116 may change his mind and select a cancel control field 708.

In this example, authorisation control 706 further comprises information relating to the purchase in the merchant application 304 that is available to the payment 308 as a result of the sending of payment data as described above. In FIG. 7, the payment data is the payment amount and the merchant name. As a result, the payer 116 is under control which payment will be authorised by selecting the authorise control 706.

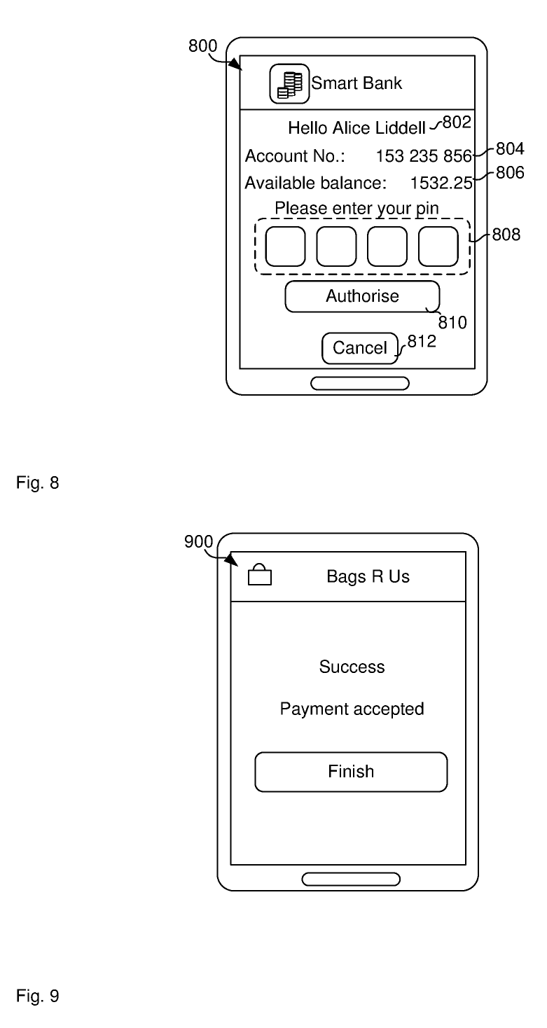

FIG. 8 illustrates another example of a payment application user interface 800. In this example, payer 116 is already logged into payment application 308 as described above. As a result, payment application 308 can access the payer's personal data that is stored by payment application 308 and therefore maintained by the payer's financial institution. In this example, payment application user interface 800 displays the payer's name 802, the payer's account number 804 with the financial institution and the available balance 806.

Since this information is only available to payment application 308 and no other application, payer 116 can verify that the payment application user interface 800 is generated by the correct payment application 308 and not by a fraudulent application that aims to intercept the user's secret pin number for malicious purposes. Similar to the user interface 700 in FIG. 7, the user interface in FIG. 8 comprises a pin input field 808, an authorise control 810 and a cancel control 812.

Processor 102, that is, payment application 308, detects this interaction of payer 116 with control 706/808 and in response, initiates payment of the given amount to the given merchant.

Once the payment is successful, the payment application 308 sends a confirmation message to merchant application 304 and activates the merchant application 304.

FIG. 9 illustrates a payment confirmation user interface 900 that is displayed as a result of the processor 102 activating the merchant application 304 after the successful payment. The payment application 308 sends payment confirmation data to the merchant application 304 and merchant application 304 receives the payment confirmation data, such that the merchant application 304 can inform payer 116 that the payment has been successful and that the goods or services are now available, that is, the goods are being shipped to a specified delivery address, media items are ready for download or special game features are now accessible.

It is noted here that the communication between the merchant application 304 and the payment application 308 does not contain personal information or otherwise sensitive information, such as the payer's name or address or credit card information. As a result, the communication between these application may be implemented with a low standard of security and encryption.

However, in order to avoid fraudulent messages that pretend that a payment has been made without the actual payment having occurred, the communication between the merchant application 304 and the payment application 308 may be secured against modification by using secure signatures. In that example, the SDK provided in order to implement the payment functionality in merchant application 304 comprises a mechanism to retrieve public keys associated with payment applications 306 and 308. For example, public keys may be stored within the SDK or the SDK may contain an IP address or URL of a public key server. Similarly, payment applications 306 and 308 may retrieve a public key of the merchant server 304. As a result, merchant application 304 and payment applications 306 and 308 can generate and add cryptographic signatures to their messages which can be verified by the receiving application using the public keys.

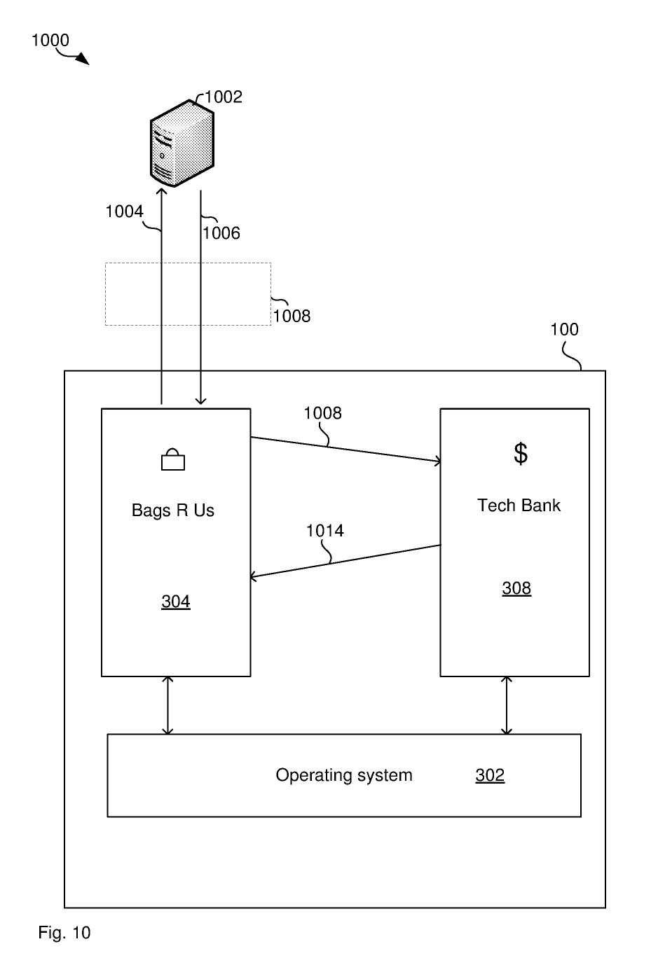

FIG. 10 illustrates a computer network 1000 comprising a management server 1002 for managing payment applications to supplement the example above where the processor accesses a flag associated with a payment application to indicate that this payment application can receive payment data. In the example of FIG. 10, merchant server 1002 hosts a list of all payment applications that can receive payment data. This list may be maintained by a third party. Merchant application 304 sends a query 1004 to server 1002 and receives 1006 a list of all enabled payment applications. The list of payment applications may comprise for each payment application an application name, application version number, associated developer organisation, unique fingerprint or cryptographic signature or the like. In one example, the communication between the merchant application 304 and the server 1002 is facilitated by a financial institution 1008 of the merchant.

Processor 102 can then determine which payment application is on the list as well as installed on device 100 by matching installed applications with the information in the list received from server 1002. Processor 102 can then generate a selection user interface as described with reference to FIG. 6.

It will be appreciated by persons skilled in the art that numerous variations and/or modifications may be made to the specific embodiments without departing from the scope as defined in the claims.

It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publically accessible network such as the internet.

It should also be understood that, unless specifically stated otherwise as apparent from the following discussion, it is appreciated that throughout the description, discussions utilising terms such as “estimating” or “processing” or “computing” or “calculating”, “optimising” or “determining” or “displaying” or “maximising” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

The present embodiments are, therefore, to be considered in all respects as illustrative and not restrictive.

1. A method for facilitating payment by a payer using a payee application installed on a mobile communication device, the method comprising:
detecting an interaction by the payer with respect to the payee application to initiate a payment;
in response to detecting the interaction selecting one of multiple payment applications installed on the mobile communication device;
activating the one of the multiple payment applications to allow the payer to interact with the one of the multiple payment applications using a graphical user interface provided by the one of the multiple payment applications; and
sending payment data associated with the payment from the payee application to the one of the multiple payment applications to facilitate the payment.

2. The method of claim 1, wherein selecting the one of multiple payment applications is based on an indication associated with each of the multiple payment applications of whether that payment application accepts payment data.

3. The method of claim 1, wherein selecting the one of multiple payment applications comprises receiving user input indicative of a selection of the one of the multiple payment applications by the user.

4. The method of claim 1, wherein each of the multiple payment applications is associated with a bank.

5. The method of claim 1, further comprising:
receiving from a server data indicative of a set of payment applications that accept payment data; and
determining for each of the multiple payment applications installed on the mobile communication device whether that payment application corresponds to an item in the received set of payment applications.

6. The method of claim 1, wherein the steps of activating and sending are performed in a single step of calling the one of the multiple payment applications using the payment data as a parameter for calling the one of the multiple payment applications.

7. The method of claim 1, wherein activating the one of the multiple payment applications comprises accessing payer account data associated with the one of the multiple payment applications and the payer and displaying the payer account data to the payer.

8. The method of claim 1, wherein activating the one of the multiple payment applications comprises starting a new process associated with the one of the multiple payment applications.

9. The method of claim 1, wherein activating the one of the multiple payment applications comprises identifying a process associated with the one of the multiple payment applications and switching a user interface to the identified process.

10. The method of claim 1, further comprising after the step of activating the one of the multiple payment applications receiving by the one of the multiple payment applications from the payer an indication to authorise the payment.

11. The method of claim 10, wherein the indication comprises authentication data to authenticate the payer with the one of the multiple payment applications.

12. The method of claim 1, further comprising receiving from the one of the multiple payment applications a payment confirmation message and creating a display that indicates that the payment is confirmed.

13. A non-transitory computer readable medium with an executable program stored thereon that when executed causes a computer to perform the method of claim 1.

14. A mobile communication device for facilitating payment by a payer using a payee application installed on the mobile communication device, the mobile communication device comprising:
an input port to detect an interaction by the payer with respect to the payee application to initiate a payment;
a processor to
select in response to detecting the interaction one of multiple payment applications installed on the mobile communication device,
activate the one of the multiple payment applications to allow the payer to interact with the one of the multiple payment applications using a graphical user interface provided by the one of the multiple payment applications, and
to send payment data associated with the payment from the payee application to the one of the multiple payment applications to facilitate the payment.
